(19) United States
(12) Patent Application Publication
(10) Pub. No.: US 2018/0156318 A1
(43) Pub. Date: Jun. 7, 2018

(54) Non-beam Pumping Unit with a Motor Output Shaft Righting Device

(71) Applicant: Zhishen Su, Daqing (CN)

(72) Inventor: Zhishen Su, Daqing (CN)

(21) Appl. No.: 15/658,425

(22) Filed: Jul. 25, 2017

(30) Foreign Application Priority Data
Dec. 6, 2016 (CN) 201621326265.1

(51) Int. Cl. F16H 7/14; F04B 47/02; F04B 53/22

(52) U.S. Cl. CPC F16H 7/14; E21B 43/126; F04B 53/22; F04B 47/026

(57) ABSTRACT

The utility belongs to the field of the non-beam pumping unit, specifically relating to a non-beam pumping unit with a motor output shaft righting device. The non-beam pumping unit with a motor output shaft righting device comprises a base, a tower body and a drive mechanism. The base is fixedly mounted on the ground. The drive mechanism is mounted on the platform, comprising a motor, a large roller, a small roller, a belt and a counterweight device. The motor is connected with the large roller through a chain and sprockets, and one end of the belt is connected with a beam hanger and the other end hangs down after wrapping around the large roller and the small roller from the upper side and then connected with the counterweight device.

### BACKGROUND OF THE INVENTION

### 1. Field of the Invention

The utility belongs to the field of the non-beam pumping unit, specifically relating to a non-beam pumping unit with a motor output shaft righting device.

### 2. Description of the Related Art

In the petroleum exploitation, the pumping unit is one of the most commonly used oil extraction equipment and most of the pumping units used in the prior art are beam pumping units. There are problems like low mechanical transmission efficiency, high power consumption, difficulty in maintenance and high fault rate in beam pumping units due to their physical structures.

To solve these problems, researchers have developed a non-beam pumping unit.

The existing non-beam pumping unit typically comprises a base, a tower body mounted on the base and a drive mechanism mounted on a platform at the top of the tower body. The drive mechanism comprises a motor, a roller, a belt and a counterweight device and two ends of the belt are connected with a beam hanger and the counterweight device of the pumping unit respectively. The belt is wrapped around the roller from the upper side of the roller. The motor drives the roller to rotate through the chain so that the beam hanger at both ends of the belt and the counterweight device are moved up and down through driving by the belt, thus achieving the oil pumping of the pumping unit. During the operation of the non-beam pumping unit, the output shaft of the motor needs to bear a large bending moment, which will adversely affect the stability of the motor operation and cause damage to the output shaft of the motor and the bearing after a long-time operation.

### SUMMARY OF THE INVENTION

The utility provides a non-beam pumping unit with a motor output shaft righting device to solve the problems proposed in the above-mentioned background art.

The utility solves the technical problems by adopting the following technical solutions: the utility provides a non-beam pumping unit with a motor output shaft righting device, comprising a base, a tower body and a drive mechanism, wherein the base is fixedly mounted on the ground; the lower end of the tower body is hinged on the base, and a pull rod is connected between the tower body and the base and both ends of the pull rod are respectively hinged on the tower body and the base, and the hinge point between the tower body and the base and two end points of the pull rod constitute a triangular supporting structure and the upper end of the tower body is provided with a platform; the drive mechanism is mounted on the platform, comprising a motor, a large roller, a small roller, a belt and a counterweight device. The motor is connected with the large roller through a chain and sprockets, and one end of the belt is connected with a beam hanger and the other end hangs down after wrapping around the large roller and the small roller from the upper side and then connected with the counterweight device. The end of the output shaft of the motor is provided with a shaft end righting mechanism and the shaft end righting mechanism comprises a righting support A, an adjusting support and an adjusting screw A. The righting support A and the adjusting support are fixedly mounted on the platform and the adjusting support is located between the righting support A and the large roller. The shaft end of the output shaft of the motor is inserted into the shaft hole on the righting support A and the mounting hole for fixing the righting support A is a long hole. The adjusting screw A is a long bolt and is screwed to the adjusting support, and the end of the adjusting screw A is abutted against the righting support A.

The shaft end righting mechanism can be replaced with another structure, comprising a righting support B, an adjusting screw B and a sliding bearing seat. The righting support B is fixedly mounted on the platform and the top end of the righting support B is provided with a guide hole in the horizontal direction. The sliding bearing seat is provided with a guide post that matches with the guide hole. The adjusting screw B is screwed to the righting support B and abutted against the end of the guide post, to achieve an axial limit to the sliding bearing seat. The side of the guide post is provided with a locking bolt that is screwed to the righting support B and abutted against the side of the guide post. The guide hole is a square hole. The sliding bearing seat is fixed with a bearing bush and the inner side of the bearing bush is provided with an arc surface with the curvature of less than 180° matching with the output shaft of the motor, and the bearing bush is located on the connection of two sprockets and is made of copper tin alloy. The sliding bearing seat is provided with a guide inclined surface facing the upper and lower sides of one end of the output shaft of the motor respectively.

The pull rod is provided with a length adjusting screw. A ball socket bearing is provided between the shaft end of the output shaft of the motor and the inner wall of the shaft hole on the righting support A.

The utility has the following beneficial effects:

1. According to the utility, a righting mechanism is provided at the shaft end of the output shaft of the motor, to effectively eliminate the bending tendency of the output shaft of the motor, improve the stability of operation of the motor and extend the service life of the output shaft of the motor and the bearing. The invention provides two shaft end righting mechanisms. One righting mechanism adopts the universal bearing component and the bearing surrounds the output shaft of the motor; therefore, the structure has the advantages of stable supporting and long service life. The other righting mechanism is a semi-enclosed structure and the bearing is only supported in the bending direction of the motor output shaft. Compared with the previous structure, the structure has a slight decrease in the supporting stability, but it is easy to install and maintain, to improve the maintenance efficiency and reduce the maintenance cost, thus reducing the impact of equipment maintenance on the production.
2. The righting support A can be supported firmly by setting the adjusting screw A, to ensure the stability of the position of the righting support A. The support position of the adjusting screw A corresponds to the actual position of the righting support A by changing the screwing length of the adjusting screw A.
3. The tower body is hinged on the base, and the support of the pull rod can be removed during the well repair and the tower body is turned to the horizontal position, to facilitate to make room for the well repair operation. A movable joint is provided in the middle of the pull rod. At the movable joint, the lower sides of two pull rods are connected with a plug pin and the upper sides of two pull rods are hinged with a pin shaft. During the well repair, the pull rod will fold with the turn-over of the tower body by unplugging the plug pin. Therefore, the setting of the movable joint facilitates to more conveniently and quickly remove and restore the support function of the pull rod.
4. The pull rod is provided with a length adjusting screw and the angle of inclination of the tower body can be finely adjusted with the length adjusting screw.
5. A ball socket bearing is provided between the shaft end of the output shaft of the motor and the inner wall of the shaft hole on the righting support A, so that the angle between the output shaft of the motor and the righting support A can be adjusted within a certain range, thus reducing the requirements for the installation accuracy of the righting support A and avoiding the wear of the shaft caused by the error of parallelism between the output shaft of the motor and the axis of the shaft hole.

### BRIEF DESCRIPTION OF THE DRAWINGS

FIG. 1 is a structural schematic diagram of the utility;

FIG. 2 is a structural schematic diagram of the drive mechanism in embodiment I;

FIG. 3 is a partial enlarged view of A in FIG. 2;

FIG. 4 is a structural schematic diagram of the drive mechanism in embodiment II;

FIG. 5 is a partial enlarged view of B in FIG. 4.

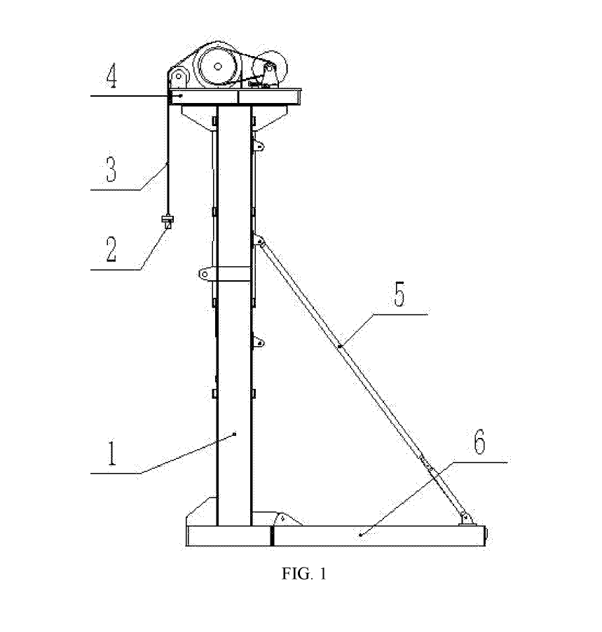

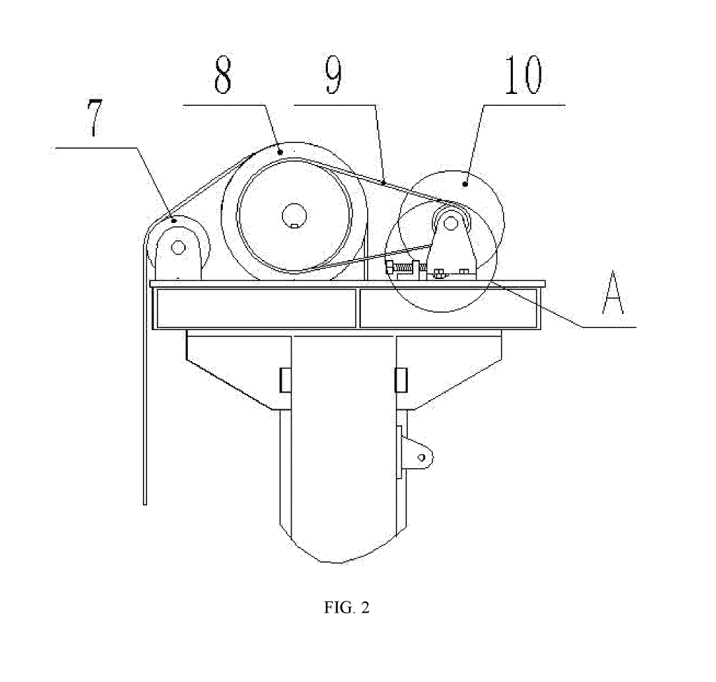

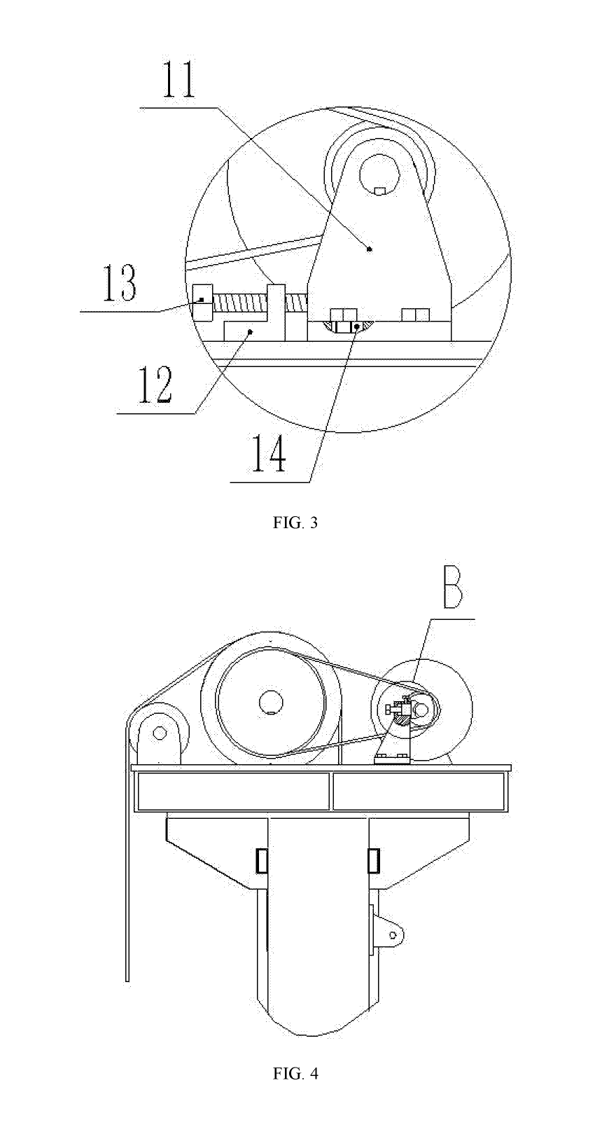

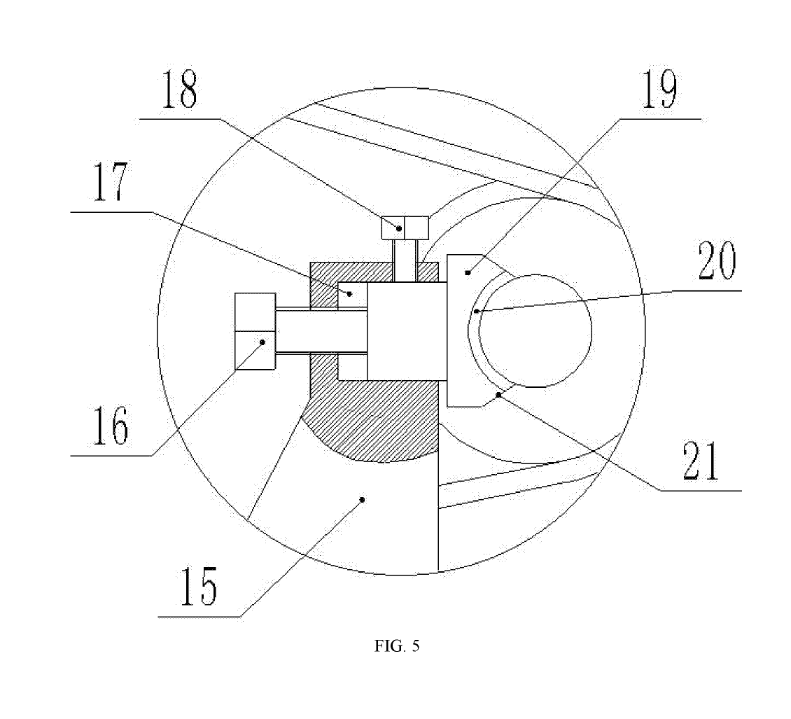

In figures: 1—tower body, 2—beam hanger, 3—belt, 4—platform, 5—pull rod, 6—base, 7—small roller, 8—large roller, 9—chain, 10—motor, 11—righting support A, 12—adjusting support, 13—adjusting screw A, 14—long hole, 15—righting support B, 16—adjusting screw B, 17—guide hole, 18—locking bolt, 19—sliding bearing seat, 20—self-lubricating bearing, 21—guide inclined surface.

### DETAILED DESCRIPTION OF THE PREFERRED EMBODIMENTS

The utility is further described as follows with reference to the drawings:

Embodiment I: According to the embodiment, the non-beam pumping unit with a motor output shaft righting device comprises a base 6, a tower body 1 and a drive mechanism, wherein the base 6 is fixedly mounted on the ground.

The lower end of the tower body 1 is hinged on the base 6, and the support of the pull rod 5 can be removed during the well repair and the tower body 1 is turned to the horizontal position, to facilitate to make room for the well repair operation.

A pull rod 5 is connected between the tower body 1 and the base 6 and both ends of the pull rod 5 are respectively hinged on the tower body 1 and the base 6, and the hinge point between the tower body 1 and the base 6 and two end points of the pull rod 5 constitute a triangular supporting structure, thus forming a stable triangle support for the tower body 1. A movable joint is provided in the middle of the pull rod 5. At the movable joint, the lower sides of two connected pull rods 5 are connected with a plug pin 16 and the upper sides of two connected pull rods 5 are hinged with a pin shaft 15. During the well repair, the pull rod 5 will fold with the turn-over of the tower body 1 by unplugging the plug pin 16. Therefore, the setting of the movable joint facilitates to more conveniently and quickly remove and restore the support function of the pull rod 5.

The upper end of the tower body 1 is provided with a platform 4. The drive mechanism is mounted on the platform 4, comprising a motor 10, a large roller 8, a small roller 7, a belt 3 and a counterweight device. The motor 10 is connected with the large roller 8 through a chain 9 and sprockets, and one end of the belt 3 is connected with a beam hanger 2 and the other end hangs down after wrapping around the large roller 8 and the small roller 7 from the upper side and then connected with the counterweight device.

The end of the output shaft of the motor 10 is provided with a shaft end righting mechanism and the shaft end righting mechanism comprises a righting support A 11, an adjusting support 12 and an adjusting screw A 13. The righting support A 11 and the adjusting support 12 are fixedly mounted on the platform 4 and the adjusting support 12 is located between the righting support A 11 and the large roller 8. The shaft end of the output shaft of the motor 10 is inserted into the shaft hole on the righting support A 11 and the mounting hole for fixing the righting support A 11 is a long hole 14. The adjusting screw A 13 is a long bolt and is screwed to the adjusting support 12, and the end of the adjusting screw A 13 is abutted against the righting support A 11. A righting mechanism is provided at the shaft end of the output shaft of the motor 10, to effectively eliminate the bending tendency of the output shaft of the motor 10, improve the stability of operation of the motor 10 and extend the service life of the output shaft of the motor 10 and the bearing. The righting support A 11 may cause the relative displacement of the hole and the shaft in the axial direction under the action of the output shaft of the motor 10. The righting support A 11 can be supported firmly by setting the adjusting screw A 13, to ensure the stability of the position of the righting support A 11. The support position of the adjusting screw A 13 corresponds to the actual position of the righting support A 11 by changing the screwing length of the adjusting screw A 13.

The pull rod 5 is provided with a length adjusting screw (the length adjusting screw is a common structure, which will not be repeated here) and the angle of inclination of the tower body 1 can be finely adjusted with the length adjusting screw.

A ball socket bearing is provided between the shaft end of the output shaft of the motor 10 and the inner wall of the shaft hole on the righting support A 11, so that the angle between the output shaft of the motor 10 and the righting support A 11 can be adjusted within a certain range, thus reducing the requirements for the installation accuracy of the righting support A 11 and avoiding the wear of the shaft caused by the error of parallelism between the output shaft of the motor 10 and the axis of the shaft hole.

Embodiment II: The difference between the technical solution described in the embodiment and that in embodiment I is: The shaft end righting mechanism is replaced with another structure, comprising a righting support B 15, an adjusting screw B 16 and a sliding bearing seat 19. The righting support B 15 is fixedly mounted on the platform 4 and the top end of the righting support B 15 is provided with a guide hole 17 in the horizontal direction. The sliding bearing seat 19 is provided with a guide post that matches with the guide hole 17. The adjusting screw B 16 is screwed to the righting support B 15 and abutted against the end of the guide post, to achieve an axial limit to the sliding bearing seat 19.

The side of the guide post is provided with a locking bolt 18 that is screwed to the righting support B 15 and abutted against the side of the guide post. The sliding bearing seat 19 is fixed with a bearing bush 20. The guide post is locked by the locking bolt 18 to reduce the vibration of the sliding bearing seat 19 during operation, thus improving the support stability and delaying the wear of the bearing bush 20.

The guide hole 17 is a square hole, so that the guide post does not rotate in the guide hole 17. It is ensured that the axis of the bearing bush 20 is consistent with the direction of the axis of the output shaft of the motor 10 and is favorable for better matching the bearing bush 20 with the output shaft of the motor 10 to avoid abnormal wear of the bearing bush 20.

The inner side of the bearing bush 20 is provided with an arc surface with the curvature of less than 180° matching with the output shaft of the motor 10, so that the bearing bush 20 can be mounted from the side of the output shaft of the motor 10 rather than sleeved from the shaft end, thus improving the assemblability of the bearing bush and the shaft, improving the maintenance efficiency and reducing the maintenance cost.

The bearing bush 20 is located on the connection of two sprockets to ensure that the bearing bush 20 can effectively support and prevent the bending tendency of the output shaft of the motor 10.

The bearing bush 20 is made of copper tin alloy that is a self-lubricating material. The bearing bush 20 made of this material is used without a lubricant and is more convenient to maintain.

The sliding bearing seat 19 is provided with a guide inclined surface 21 facing the upper and lower sides of one end of the output shaft of the motor 10 respectively. The wedge generated by the intersection of the guide inclined surface 21 and the inclined surface inside the bearing bush 20 can effectively remove (but cannot completely remove) the dust and other particles adsorbed on the output shaft of the motor 10, to a certain extent, to avoid dust from entering the space between the bearing bush 20 and the shaft, thus delaying the wear of the bearing bush 20 and the shaft.

1. A non-beam pumping unit with a motor output shaft righting device, comprising a base (6), a tower body (1) and a drive mechanism, wherein the base (6) is fixedly mounted on the ground; the lower end of the tower body (1) is hinged on the base (6), and a pull rod (5) is connected between the tower body (1) and the base (6) and both ends of the pull rod (5) are respectively hinged on the tower body (1) and the base (6), and the hinge point between the tower body (1) and the base (6) and two end points of the pull rod (5) constitute a triangular supporting structure and the upper end of the tower body (1) is provided with a platform (4); the drive mechanism is mounted on the platform (4), comprising a motor (10), a large roller (8), a small roller (7), a belt (3) and a counterweight device. The motor (10) is connected with the large roller (8) through a chain (9) and sprockets, and one end of the belt (3) is connected with a beam hanger (2) and the other end hangs down after wrapping around the large roller (8) and the small roller (7) from the upper side and then connected with the counterweight device. The end of the output shaft of the motor (10) is provided with a shaft end righting mechanism and the shaft end righting mechanism comprises a righting support A (11), an adjusting support (12) and an adjusting screw A (13). The righting support A (11) and the adjusting support (12) are fixedly mounted on the platform (4) and the adjusting support (12) is located between the righting support A (11) and the large roller (8). The shaft end of the output shaft of the motor (10) is inserted into the shaft hole on the righting support A (11) and the mounting hole for fixing the righting support A (11) is a long hole (14). The adjusting screw A (13) is a long bolt and is screwed to the adjusting support (12), and the end of the adjusting screw A (13) is abutted against the righting support A (11).

2. The non-beam pumping unit with a motor output shaft righting device according to claim 1, wherein the shaft end righting mechanism is replaced with another structure, comprising a righting support B (15), an adjusting screw B (16) and a sliding bearing seat (19). The righting support B (15) is fixedly mounted on the platform (4) and the top end of the righting support B (15) is provided with a guide hole (17) in the horizontal direction. The sliding bearing seat (19) is provided with a guide post that matches with the guide hole (17). The adjusting screw B (16) is screwed to the righting support B (15) and abutted against the end of the guide post, to achieve an axial limit to the sliding bearing seat (19). The side of the guide post is provided with a locking bolt (18) that is screwed to the righting support B (15) and abutted against the side of the guide post. The guide hole (17) is a square hole. The sliding bearing seat (19) is fixed with a bearing bush (20) and the inner side of the bearing bush (20) is provided with an arc surface with the curvature of less than 180° matching with the output shaft of the motor (10), and the bearing bush (20) is located on the connection of two sprockets and is made of copper tin alloy. The sliding bearing seat (19) is provided with a guide inclined surface (21) facing the upper and lower sides of one end of the output shaft of the motor (10) respectively.

3. The non-beam pumping unit with a motor output shaft righting device according to claim 1, wherein the pull rod (5) is provided with a length adjusting screw.

4. The non-beam pumping unit with a motor output shaft righting device according to claim 1, wherein a ball socket bearing is provided between the shaft end of the output shaft of the motor (10) and the inner wall of the shaft hole on the righting support A (11).
